(19) United States
(12) Patent Application Publication
(10) Pub. No.: US 2026/0038916 A1
(43) Pub. Date: Feb. 5, 2026

(54) THERMAL INSULATION BARRIER

(71) Applicant: ILLINOIS TOOL WORKS INC., Glenview, IL (US)

(72) Inventors: Florent Michel MANGION, Molliens-Dreuil (FR); Emma MINELLI, Milan (IT); Jinling WANG, Hanau (DE); Ignatius DE WILDE, Kortgene (NL)

(21) Appl. No.: 19/284,798

(22) Filed: Jul. 30, 2025

(30) Foreign Application Priority Data
Jul. 30, 2024 (EP) 24191848.1
Jun. 12, 2025 (DE) 10 2025 123 105.2

(51) Int. Cl. H01M 10/658; H01M 50/147; H01M 50/204; H01M 50/342

(52) U.S. Cl. CPC H01M 10/658; H01M 50/147; H01M 50/3425; H01M 50/204; H01M 2200/20

(57) ABSTRACT

The present disclosure provides a thermal insulation barrier for a battery cell. The battery cell has a top plate with a vent. The thermal insulation barrier has a thermal insulation layer with an adhesive on one side for adhering the thermal insulation layer to the top plate. The thermal insulation layer also comprises a flap aligned with the vent in the top plate. The adhesive extends about a perimeter of the flap. The thermal insulation layer comprises an adhesive-free region aligned with the flap.

### RELATED APPLICATIONS

The present application claims the benefit of European (EP) Patent Application No. 24191848.1, filed Jul. 30, 2024, and to German (DE) Patent Application No. 102025123105.2, filed Jun. 12, 2025. The entireties of European (EP) Patent Application No. 24191848.1 and German (DE) Patent Application No. 102025123105.2 are expressly incorporated herein by reference.

### FIELD OF THE DISCLOSURE

The present disclosure relates to a thermal insulation barrier, in particular, but not limited to, a thermal insulation barrier for a battery cell having a top plate with a vent.

### BACKGROUND

It is generally known that in certain situations battery cells can overheat and catch fire. When a large number of battery cells are packed into a small space, such as in a battery pack for a vehicle, there is an increased risk of overheating. When the heat generated by an overheating battery exceeds the amount of heat dissipated to its surroundings, the increase in temperature in accelerated in a process known as thermal runaway. It is desirable to isolate battery cells from each other so as to prevent thermal runaway from propagating from cell to cell within the battery pack.

### SUMMARY

According to an aspect, there is provided a thermal insulation barrier for a battery cell having a top plate with a vent, comprising: a thermal insulation layer comprising an adhesive on one side for adhering the thermal insulation layer to the top plate, wherein the thermal insulation layer comprises a flap aligned with the vent in the top plate during use, and wherein the adhesive extends about a perimeter of the flap, and wherein the thermal insulation layer comprises an adhesive-free region aligned with the flap.

This arrangement allows the thermal insulation layer to cover and protect the vent of the battery cell during normal operation. The thermal insulation layer acts to isolate the battery cell from heat and hot gases ejected from other battery cells, for example during thermal runaway. When a pressure within the battery cell exceeds a certain limit, then the release of pressure from the battery cell causes the flap to lift for venting. Therefore, controlled venting is provided, reducing the risk of overheating and thermal runaway from one battery cell to another.

In examples, the adhesive and/or the flap is configured such that the flap opens when a predetermined pressure exerted on the flap from the vent in the top plate is exceeded. The predetermined pressure may be termed a threshold pressure. For example, the amount or type of adhesive extending about the perimeter of the flap is configured to peel or break when the predetermined pressure is reached. In examples, the amount of adhesive is a thickness of the adhesive, and in other examples the amount of adhesive is a surface area of the adhesive extending about the perimeter of the flap. Different types of adhesive may have different adhesive holding strengths, and therefore the type of adhesive may be selected to detach or peel at the predetermined pressure.

In examples, the predetermined pressure is at most 0.1 MPa. In examples, the predetermined pressure is at most 0.5 MPa, or at most 0.4 MPa, or at most 0.3 MPa, or at most 0.2 MPa.

Advantageously, the predetermined pressure is less than a pressure required to separate the thermal insulation layer from the top plate because the adhesive-free region provides a lower release pressure at the vent than in the other areas of the thermal insulation layer. In this way, the thermal insulation layer isolates the battery cells from each other.

In examples, the thermal insulation layer comprises a plurality of flaps each forming a vent aligned with a respective vent in a battery cell assembly. The thermal insulation layer can be adhered across a plurality of battery cells.

In examples, the flap has a circular or ovular shape, or a polygonal shape. In examples, the flap defines an enclosed space in which the adhesive-free region is located. In examples, the flap is formed by a through-cut or line or weakness in the thermal insulation layer. The through-cut or line of weakness may extend along a circular, oval or polygonal path. The through-cut or line of weakness is preferably an incomplete loop, leaving an attachment between the flap and the rest of the thermal insulation layer. The attachment may act as a hinge when the flap opens. The line of weakness may be a perforated line or partially-cut line forming a weakness in the thermal insulation layer that is broken or separated as the flap opens. Such a through-cut or line of weakness controls the location of the edges of the flap when the flap opens.

In examples, the thermal insulation layer is formed of a material comprising one or more of mica, silicone, ceramic and rubber. These materials are stable at high temperatures, and can withstand the temperatures reached during thermal runaway.

In examples, the thermal insulation barrier is formed of a fabric or film comprising one or more of: mica, silicone and ceramic.

According to another aspect, there is provided a battery cell, comprising: a top plate with a vent, and a thermal insulation barrier, comprising: a thermal insulation layer comprising an adhesive on one side for adhering the thermal insulation layer to the top plate, wherein the thermal insulation layer comprises a flap for forming a vent aligned with the vent in the top plate during use, and wherein the adhesive extends about a perimeter of the flap, and wherein the thermal insulation layer comprises an adhesive-free region aligned with the flap.

According to another aspect, there is provided a battery assembly comprising a plurality of battery cells, each battery cell having a top plate with a vent, and a thermal insulation barrier, comprising: a thermal insulation layer comprising an adhesive on one side for adhering the thermal insulation layer to the top plates of the battery cells, wherein the thermal insulation layer comprises a plurality of flaps for forming vents aligned with the vents in the top plates during use, and wherein the adhesive extends about a perimeters of the flaps, and wherein the thermal insulation layer comprises an adhesive-free region aligned with each of the flaps.

The battery assembly may be a secondary battery. The battery assembly may be a battery assembly for an automobile, in particular the battery assembly may be an automotive battery assembly, for example and automotive secondary battery assembly.

### BRIEF DESCRIPTION OF THE DRAWINGS

Embodiments of the disclosure are now described, by way of example only, hereinafter with reference to the accompanying drawings.

FIG. 1 illustrates a battery pack including a number of battery cells.

FIG. 2 shows a schematic illustration of a thermal insulation barrier.

FIG. 3A illustrates a thermal insulation barrier with a flap that is closed.

FIG. 3B illustrates a thermal insulation barrier with a flap that is open.

FIG. 4 illustrates a perspective view of a thermal insulation layer, and an adhesive sheet for applying an adhesive to the thermal insulation layer.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

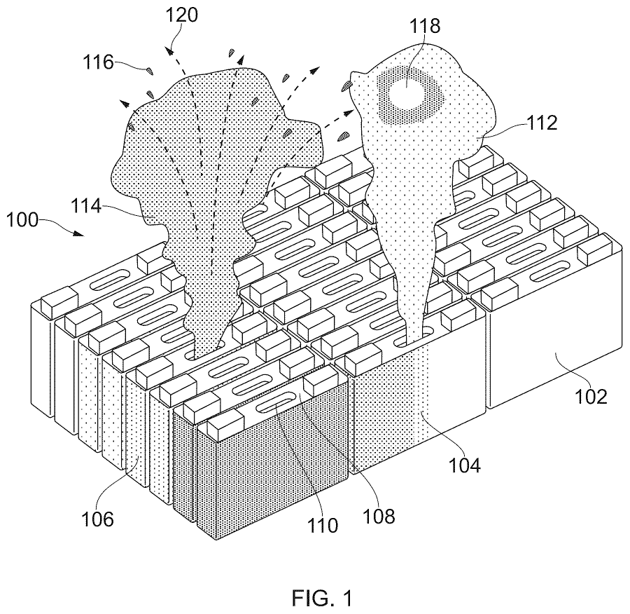

FIG. 1 shows an example of a battery assembly 100100 including a number of battery cells 102. Each battery cell 102 has a top plate 108 that is provided with a vent 110 for releasing pressure from within the battery cell 102, for example during thermal runaway. When a pressure inside the battery cell 102 exceeds a certain level, a pressure valve inside the battery cell 102 opens to release a gas 112 (e.g. see cell at location 104). If the temperature exceeds a certain level, the escaped gases 112 may combust, causing an ignition and fire 114 (e.g. see cell at location 106). This fire 114 and/or explosion causes particles 116 to be ejected outward in a direction generally denoted 120. If neighbouring battery cells 102 are not isolated or protected during overheating and/or a thermal event of a nearby battery cell 102, then the high temperature ejected particles 116 may come into contact with the gases 112 released from other battery cells 102, causing the gases 112 to also be ignited (e.g., at location 118) in a chain reaction leading to a rapid temperature increase.

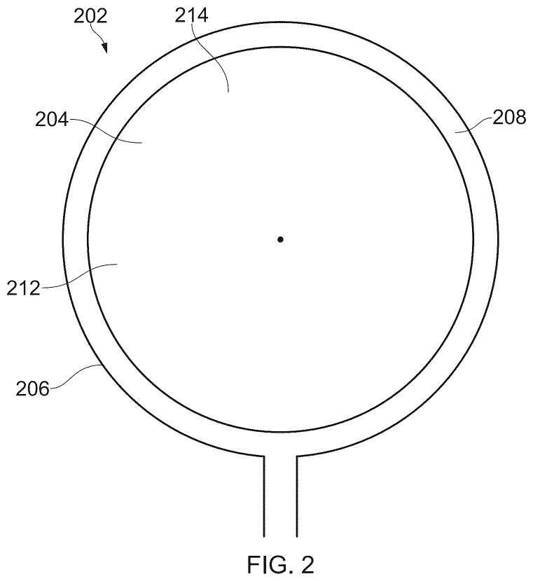

FIG. 2 shows a thermal insulation barrier 202 that includes a thermal insulation layer 204. The thermal insulation layer 204 is provided with an adhesive 208 on one side for adhering the thermal insulation layer 204 to the battery assembly, in particular the top plates (108, see FIG. 1).

A flap 212 is defined in the thermal insulation layer 204 that forms a vent. The flap 212 is defined by a cut line 206. The thermal insulation layer 204 includes an adhesive-free region 214 inward of the perimeter of the flap 212 that is aligned with the flap 212, such that the adhesive 208 extends about a perimeter of the flap 212. In this way, the flap 212 is adhered down on the battery cell in normal use. The flap 212 is sized larger than the adhesive-free region 214. In other examples, the flap 212 may be sized to correspond to the size of the adhesive-free region 214. The thermal insulation layer 204 is formed of a material that is resistant to high temperatures. In this example, the thermal insulation layer 204 is made of silicone rubber. However, it is to be appreciated that other materials may be used, for example a fabric or film comprising one or more of: mica, silicone and ceramic.

In use, the thermal insulation barrier 202 is placed onto a top plate of a battery cell such as the battery cell 102 described in FIG. 1, such that the thermal insulation layer 204 is adhered to the top plate 108 to cover the vent 110. The flap 212 is closed over the vent 110 in the adhesive-free region 214. When pressure builds up inside the battery cell 102 and exceeds a pressure limit, for example 0.8 MPa, pressure is released from inside the battery cell 102 through the vent 110. This causes the flap 212 to open, exposing the vent 110 and releasing the expelled gas. The pressure at which the flap 212 is lifted is preferably less than the release pressure of the vent 110 of the battery cell 102. In this way, the flap 212 opens immediately when gases are vented through the vent 110, reducing the likelihood of the gases penetrating between the thermal insulation layer 204 and the top plate of the battery cell.

The pressure at which the flap 212 is lifted to expose the vent 110 may be predetermined on any one or more of: the size (i.e. surface area or diameter) of the flap 212; the amount of the adhesive 208 extending about the perimeter of the flap 212; the shape of the flap 212; the thickness of the adhesive 208; the strength of the adhesive 208 (e.g., the type of the adhesive 208); and/or the thickness of the thermal insulation layer 204. In some examples, the cut line 206 is a line of weakness (e.g., a partial cut or line of perforations). In such examples the pressure at which the flap 212 is lifted may also be predetermined by the force required to break the cut line 206 to allow the flap 212 to lift.

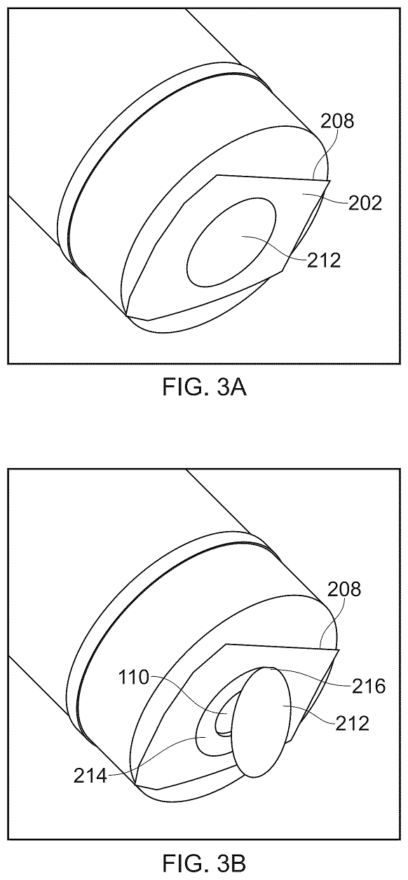

In this example, the flap 212 is circular. However, it is envisaged that the flap 212 may instead by ovular or have a polygonal shape, for example square, rectangular or triangular. The flap 212 is defined by a cut line 206, which may be a through-cut through the thickness of the thermal insulation layer 204, or a line of weakness such as a partial cut or a perforated line. The cut line 206 defines an enclosed area in which the adhesive-free region 214 is located. The cut line 206 is an incomplete loop so that when the flap 212 opens it remains attached to the rest of the thermal insulation layer 204 at a hinge (216, see FIG. 3B), as described further below.

The thermal insulation layer 204 has a thickness of 0.3 mm in this example, but other thicknesses are envisaged such as 0.2 mm to 0.5 mm, for example. In examples, the thermal insulation layer 204 may have a thickness of 0.2 mm or 0.25 mm or 0.35 mm or 0.4 mm or 0.45 mm or 0.5 mm.

FIG. 3A shows an arrangement in which the flap 212 of the thermal insulation barrier 202 is closed. The flap 212 is closed when no pressure is exerted from the vent 110 of the battery cell 102, or when a pressure exerted from the vent 110 is not sufficient to open the flap 212. This is the normal operating condition of the thermal insulation barrier 202, when no thermal runaway is happening. The flap 212 may remain in this closed state when the pressure exerted onto the flap 212 is less than or equal to 0.1 MPa, for example. The adhesive extending about the perimeter of the flap 212 holds the flap 212 closed.

Where a battery pack includes a plurality of battery cells 102, the flap 212 acts to prevent gases from entering the battery cell 102. For example, another battery cell 102 of the battery assembly 100 may be undergoing thermal runaway and releasing hot gases, and the flap 212 acts to seal the battery cell 102 to prevent or delay cell-to-cell propagation of the thermal runaway. This is advantageous because it isolates battery cells 102 from one another, preventing the acceleration of battery heating.

As shown in FIG. 3B, when the pressure exerted from the vent 110 below the flap 212 exceeds a predetermined pressure limit, the flap 212 is opened to expose the vent 110 and to allow gases to be expelled. The flap 212 is attached at one side at a hinge 216. In this example, the flap 212 is configured to open when a pressure exerted onto the flap 212 from underneath exceeds 0.1 MPa. Once the flap 212 is open gases are vented from the battery cell 102 into a larger battery housing or enclosure. The battery housing or enclosure preferably includes an overpressure vent for venting the gases to atmosphere. The thermal insulation layer 204 overlying the other battery cells 102 act to prevent or delay the gases entering the other battery cell 102 to prevent or delay thermal runaway in the other battery cells 102.

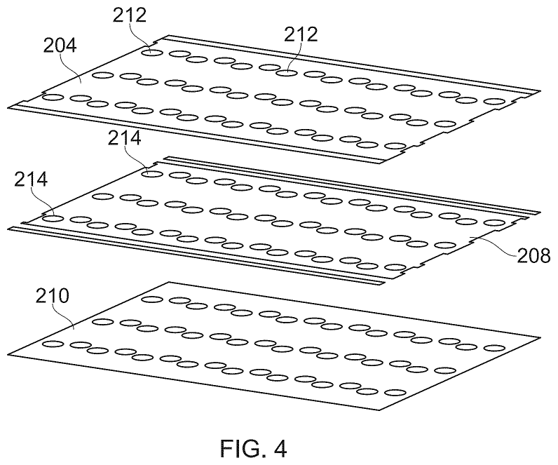

FIG. 4 illustrates the thermal insulation barrier 202. The thermal insulation barrier 202 includes the thermal insulation layer 204, the adhesive 208 and a liner 210.

A plurality of flaps 212 are pre-cut in the thermal insulation layer 204. The adhesive 208 is applied to the underside of the thermal insulation layer 204, leaving adhesive-free regions 214 aligned with the flaps 212. The liner 210 covers the adhesive 208 and is removed before adhering the thermal insulation barrier 202 to a battery assembly 100 such as that shown in FIG. 1. Each flap 212 is positioned to over a vent 110 of a battery cell 102 of the battery assembly 100. In this way, the thermal insulation layer 204 covers a plurality of battery cells 102 and provides a flap 212 for one or more of the battery cells 102. Preferably the thermal insulation layer 204 comprises one or more flaps 212, for example one flap 212, for each vent 110.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

What is claimed is:

1. A thermal insulation barrier for a battery cell having a top plate with a vent, comprising:
a thermal insulation layer comprising an adhesive on one side for adhering the thermal insulation layer to the top plate,
wherein the thermal insulation layer comprises a flap aligned with the vent in the top plate during use, and
wherein the adhesive extends about a perimeter of the flap, and wherein the thermal insulation layer comprises an adhesive-free region aligned with the flap.

2. The thermal insulation barrier of claim 1, wherein at least one of the adhesive or the flap is configured such that the flap opens when a predetermined pressure exerted on the flap from the vent in the top plate is exceeded.

3. The thermal insulation barrier of claim 1, wherein the predetermined pressure is at most 0.5 MPa.

4. The thermal insulation barrier of claim 1, wherein the thermal insulation layer comprises a plurality of flaps each forming a vent aligned with a respective vent in a battery cell assembly.

5. The thermal insulation barrier of claim 1, wherein the flap is defined by a line of weakness or through-cut formed in the thermal insulation layer.

6. The thermal insulation barrier of claim 1, wherein the predetermined pressure is at least partly configured based on one or more of: a size of the flap; an amount of the adhesive extending about the perimeter of the flap; a shape of the flap; a thickness of the adhesive; a strength or type of the adhesive; or a thickness of the thermal insulation layer.

7. The thermal insulation barrier of claim 1, wherein the flap is defined by a line of weakness formed in the thermal insulation layer, and wherein the predetermined pressure is at least partly configured based on a breaking force of the line of weakness.

8. The thermal insulation barrier of claim 1, wherein the flap is one of: circular, ovular, or polygonal.

9. The thermal insulation barrier of claim 1, wherein the flap comprises a hinge configured to remain attached to the thermal insulation layer when the flap opens.

10. The thermal insulation barrier of claim 1, comprising a plurality of flaps formed in the thermal insulation layer.

11. The thermal insulation barrier of claim 1, wherein the thermal insulation layer comprises one or more of: mica, silicone, ceramic and rubber.

12. The thermal insulation barrier of claim 1, further comprising a liner covering the adhesive, the liner being removable before assembly of the thermal insulation barrier with a battery cell.

13. A battery cell, comprising: a top plate with a vent, and a thermal insulation barrier according to claim 1.

14. A battery assembly, comprising a plurality of battery cells, each battery cell having a top plate with a vent, and a thermal insulation barrier, comprising:
a thermal insulation layer comprising an adhesive on one side for adhering the thermal insulation layer to the top plates of the battery cells,
wherein the thermal insulation layer comprises a plurality of flaps for forming vents aligned with the vents in the top plates during use,
wherein the adhesive extends about a perimeter of each flap, and
wherein the thermal insulation layer comprises an adhesive-free region aligned with each of the flaps.
